(19) United States
(12) Patent Application Publication
(10) Pub. No.: US 2023/0186057 A1
(43) Pub. Date: Jun. 15, 2023

(54) METHODS AND SYSTEMS FOR DETERMINING PHYSICAL PROBABILITIES OF PARTICLES

(71) Applicant: President and Fellows of Harvard College, Cambridge, MA (US)

(72) Inventors: Albert MUSAELIAN, Cambridge, MA (US); Simon BATZNER, Cambridge, MA (US); Boris KOZINSKY, Cambridge, MA (US)

(21) Appl. No.: 18/060,901

(22) Filed: Dec. 1, 2022

Related U.S. Application Data
(60) Provisional application No. 63/284,763, filed on Dec. 1, 2021.

(51) Int. Cl. G06N 3/047; G06N 3/082

(52) U.S. Cl. CPC G06N 3/047; G06N 3/082

(57) ABSTRACT

This disclosure presents a method for determining a physical probability, wherein the method for determining a physical probability of a particle includes obtaining, by a computing device, a spatial input of a particle, identifying by the computing device, at least a tensor element as a function of the spatial input, and determining, by the computing device, the physical probability as a function of the element using a tensor machine learning model, wherein the tensor machine learning model is trained as a function of a tensor training set that correlates a plurality of tensor elements to a plurality of physical probabilities. This disclosure also presents a method for simulating molecular dynamics, wherein the method comprises accelerating, by a computing device, a computation associated with a force of a particle.

### STATEMENT REGARDING FEDERALLY SPONSORED RESEARCH OR DEVELOPMENT

This invention was made with support from the United States government under DE-SC0021110 awarded by the Department of Energy. The United States government has certain rights to this invention.

### BACKGROUND OF THE INVENTION

An accurate computational description of the many-body correlations of interacting particles is a long-standing goal in the natural sciences, in particular in the modeling of molecules and materials. Message Passing Neural Networks (MPNNs) have emerged as the leading paradigm for Machine Learning on molecules and materials, driven by their ability to accurately learn many body correlations by iteratively propagating information along an atomistic graph. MPNNs, however, are difficult to parallelize and come with a low level of interpretability. In this work, we develop a machine learning model that learns many-body correlations among particles without the need for message passing, convolutions, or attention mechanisms.

### SUMMARY OF THE INVENTION

In one aspect, the invention provides a method for determining a physical probability of a particle. The method includes obtaining, by a computing device, a spatial input of a particle, identifying, by the computing device, at least a tensor element as a function of the spatial input, determining, by the computing device, the physical probability as a function of the tensor element using a tensor machine model trained as a function of a tensor training set that correlates a plurality of tensor elements to a plurality of physical probabilities.

In some embodiments the spatial input includes a scalar element.

In some embodiments identifying the at least a tensor element further includes determining at least an external vector and identifying the tensor element as function of the at least an external vector. In some embodiments the external vector includes a local vector. In some embodiments the external vector includes a global vector.

In some embodiments the physical probability includes a probable motion. In some embodiments, the physical probability includes a conformation likelihood. In some embodiments, the physical probability includes a reactive element.

In some embodiments, determining the physical probability includes determining a first physical probability, receiving an alternate spatial input of the particle, and generating a second physical probability as a function of the alternate spatial input.

In some embodiments determining the physical probability includes updating the tensor training set as a function of a first physical probability and determining a second physical probability as a function of the updated tensor training set.

In some embodiments, the invention provides a method for simulating molecular dynamics. The method includes accelerating, by a computing device, a computation associated with a force of a particle.

In some embodiments, the invention provides a method for performing an interpolation analysis of a plurality of forces associated with a particle. The method includes receiving, by a computing device, a plurality of forces associated with a particle from at least a quantum mechanical calculation and performing, by the computing device, an interpolation analysis of the plurality of forces associated with the particle as a function of a machine learning model.

In some embodiments, the invention provides a method for performing a regression of a plurality of forces associated with a particle. The method includes receiving, by a computing device, a plurality of atomic forces from at least a quantum mechanical calculation and performing, by the computing device, a regression analysis as a function of the plurality of atomic forces and a machine learning model.

In some embodiments, the invention provides a method for learning a plurality of forces associated with a particle. The method includes generating, by a computing device, a gradient of a total energy predicted by a neural network architecture by capturing a geometric information about a spatial element and categorical element of an alternate particle in a local neighborhood surrounding a particle and generating the gradient as a function of the geometric information using a neural network architecture. The method also includes learning, by the computing device, a plurality of forces associated with the particle as a function of the gradient.

In some embodiments, the invention provides a method for learning a plurality of forces associated with a particle by generating a gradient of a total energy. The method includes predicting, as a function of a neural network architecture that captures many-body geometric information about a spatial element and a categorical element of an alternate particle within a neighborhood of the particle in a pair relative to the alternate particle, a pairwise energy and decomposing the gradient into a sum of pairwise energy terms corresponding to all ordered pairs of alternate particles. The method also includes learning, by the computing device, a plurality of forces associated with a particle as a function of the gradient. In some embodiments, the neural network architecture is configured to be equivariant to E(3) symmetry operations. In some embodiments, the neural network architecture is configured to exchange a plurality of invariant scalar information as a function of being split into two tracks that include an E(3)-invariant track and an E(3)-equivariant track.

### DEFINITIONS

To facilitate the understanding of this invention, a number of terms are defined below. Terms defined herein have meanings as commonly understood by a person of ordinary skill in the areas relevant to the invention. Terms such as “a”, “an,” and “the” are not intended to refer to only a singular entity but include the general class of which a specific example may be used for illustration. The terminology herein is used to describe specific embodiments of the invention, but their usage does not limit the invention, except as outlined in the claims.

The term “computing device,” as used herein refers to a device and/or system that can perform computations such as but not limited to arithmetic operations, logic operations, processing operations, and/or the like thereof. In some embodiments, a computing device may include a microcontroller, microprocessor, digital signal processor (DSP), and/or system on a chip (SoC). In an embodiment, a computing device may include a single computing device operating independently, and/or a plurality of computing devices operating together to achieve a common goal. In some embodiment a computing device may be configured to perform a single step or sequence repeatedly until a desired or commanded outcome is achieved. In some embodiments, a computing device may be configured to repeat iteratively and/or recursively a step or a sequence of steps using outputs of previous repetitions as inputs to subsequent repetitions, aggregating inputs and/or outputs of repetitions to produce an aggregate result. In some embodiments, a computing device may be configured to perform any step and/or sequence of steps in parallel, wherein performing in parallel includes simultaneously and/or substantially simultaneously performing two or more steps and/or sequences of steps.

Many methodologies described herein include a step of “determining.” Those of ordinary skill in the art, reading the present specification, will appreciate that such “determining” can utilize or be accomplished through use of any of a variety of techniques available to those skilled in the art, including for example specific techniques explicitly referred to herein. In some embodiments, determining involves generating an output as a function of a tensor machine learning model. In some embodiments, determining involves consideration and/or manipulation of data or information, for example utilizing a computer or other processing unit adapted to perform a relevant analysis. In some embodiments, determining involves receiving relevant information and/or materials from a source. In some embodiments, determining involves comparing one or more features of a particle to a comparable reference.

The term “external vector,” refers to an external force generated as a function of one or more alternate particles and/or external stimuli. For example, and without limitation, an external vector may include a physical force, electrical force, and/or optical force generated as a function of an alternate particle. As a further non-limiting example, an external vector may include an external force generated as a function of one or more external stimuli such as, but not limited to, a temperature, pressure, volume, and/or the like thereof. In some embodiments, an external vector may include a local vector. As used herein, a “local vector” is an external force generated as a function of one or more adjacent particles. For example, a local force may include an external force comprising a physical force, electrical force, and/or optical force generated by a primary particle and/or adjacent particle. In some embodiments, an external vector may include a global vector. As used herein, a “global vector” is an external force generated as a function of one or more distal particles. For example, a global force may include an external force comprising a physical force, electrical force, and/or optical force generated by a secondary particle, tertiary particle, quaternary particle, and/or the like thereof.

As used herein, the terms “identify” or “identifies” refer to indicating, establishing, or recognizing the identity of a tensor element of a particle. For example, and without limitation, a tensor element of a particle may include a symmetry of a particle.

As used herein, the terms “learn,” learning,” or “learns” refer to a process of acquiring new information and/or data such that a machine learning model may be able to update one or more weights in determining an output from an input. For example, and without limitation, learning may include obtaining one or more previous outputs generated by a machine learning model and updating training data and/or a training set. As a further non-limiting example, a computing device may learn a plurality of new forces by determining one or more outputs that were previously unknown and storing the outputs in a memory, hard drive, storage unit, and/or the like thereof.

The term “particle,” as used herein refers to a small, localized object that may be defined and/or described by one or more physical properties and/or chemical properties. For example, and without limitation, a particle may include an atom, molecule, complex, and/or material. As a further non-limiting example, a particle may include subatomic particles, microscopic particles, macroscopic particles, and/or the like thereof. As a further non-limiting example, a particle may include protons, neutrons, and/or electrons.

The term “physical probability,” refers to a likely physical property of a particle in a location, space, field, vector space, and/or the like thereof. For example, a physical probability may include one or more predictions and/or probabilities of a motion of a particle. In some embodiments, a physical probability may include a probable motion. As used herein, a “probable motion” is a likely movement of a particle in a location, space, field, vector space, and/or the like thereof. For example, a probable motion may denote that a particle may be moving in a direction, at a velocity. As a further non-limiting example, probable motion may denote that a particle may exhibit one or more vibrational motions and/or Brownian motion states. In some embodiments, a physical probability may include a conformation likelihood. As used herein, a “conformation likelihood” is a predicted conformation of a particle in a location, space, field, vector space, and/or the like thereof. For example, a conformation element may denote that a particle will undergo a conformation change, shift, and/or alteration within a location, space, field space, and/or vector space. In some embodiments, a physical probability may include a reactive element. As used herein, a “reactive element” is a predicted reaction energy of a particle in a location, space, field, vector space, and/or the like thereof. For example, a reactive element may denote that a particle includes a minimum amount of energy required to undergo a chemical reaction. As a further non-limiting example, a reactive element may denote that a particle includes a higher likelihood for undergoing a chemical reaction as opposed to an alternate particle.

The term “spatial input,” as used herein, is an element of data representing a particles location within a defined space. For example, and without limitation, spatial input may include a position, location, or the like thereof of a particle within a field. As a further non-limiting example, spatial input may include a position, location, or the like thereof of a particle in space. Spatial input may include a scalar element. A “scalar element,” as used herein, is an element of data representing a vector space. For example, and without limitation, a scalar element may represent one or more directions and/or magnitudes of a vector of a plurality of vectors located in a vector space.

The term “tensor element,” as used herein, refers to an algebraic object that describes a multilinear relationship between sets of scalar elements related to a field and/or vector space. For example, and without limitation, tensor elements may describe a non-scalar element such as but not limited to a multilinear relationship between a scalar element, a vector, and/or an alternate tensor element. As a further non-limiting example, a tensor element may describe a plurality of physical forces being exerted on a particle such as stress forces, elasticity forces, moments of inertia, electromagnetic forces, magnetic forces, general relativity forces, and/or the like thereof. As a further non-limiting example, a tensor element may describe a plurality of chemical forces such as but not limited to ionic forces, covalent forces, metallic forces, electrical forces, mechanical forces, optical forces, and/or the like thereof. As a further non-limiting example, a tensor element may describe a plurality of chemical forces such as covalent bonds, non-covalent bonds (e.g., ionic bonds and coordination bonds), Van der Waals forces, magnetic forces, hydrogen bonding forces, and/or the like thereof. As a further non-limiting example, a tensor element may describe a plurality of chemical properties and/or physical properties such as symmetry, dipole moments, spectroscopic transitions, and/or the like thereof.

The term “tensor machine-learning model,” refers to a machine-learning model to produce a physical probability output given tensor elements as inputs; this is in contrast to a non-machine learning model where the commands to be executed are determined in advance through user interactions. The term “machine-learning model,” as used herein, is a mathematical and/or algorithmic representation of a relationship between inputs and outputs, wherein the machine-learning model receives an input and generates an output based on a derived relationship that is previously identified from a training set. As a further non-limiting example, a machine-learning model may include an input layer of nodes, one or more intermediate layers, and an output layer of nodes.

As used herein, the term “tensor training set” is a training set that correlates a plurality of tensor elements to a plurality of physical probabilities, wherein a training set is a set of data that contains correlations that a machine-learning process and/or machine-learning model may use to determine and/or model relationships between two or more categories of data elements.

As used herein, the terms “train,” “training,” and/or “trained,” collectively refer to the process of adjusting the connections and/or weights between nodes in adjacent layers of a neural network to approximate the desired values of the output nodes.

As used herein, any values provided in a range of values include both the upper and lower bounds, and any values contained within the upper and lower bounds.

As used herein, the term “\vec{rₗ}” used herein refers to the position of the ith particle in the system.

As used herein, the term “\vec{rₗⱼ}” re fers to the displacement of vector \vec{rⱼ}-\vec{rₗ} from i to j.

As used herein, the term “\vec{Y_{,p}^{lj}}” refers to the projection of \vec{rₗⱼ} onto the lth spherical harmonic which has parity p=(−1)^{l}.

As used herein, the term “Zᵢ” refers to the discrete species/type of particle i.

As used herein, the term “MLP( . . . )” refers to a fully connected scalar neural network, optionally with nonlinearities.

As used herein, the term “x^{ij,L=0}” refers to the scalar latent features of edge ij at layer L.

As used herein, the term “V_{n,l,p}^{ij,L=0}” refers to the equivariant (scalar and tensor) latent features of edge ij at layer L which are indexed by the rotation order l ∈ 0,1 E 0,1 . . . , lₘₐₓ and parity p ∈ −1,1. The n index runs over the multiplicities 0, . . . , n_{equivariant} where n_{equivariant} is a hyperparameter.

### BRIEF DESCRIPTION OF THE DRAWINGS

FIG. 1A is a schematic diagram illustrating an exemplary embodiment of a system of particles

FIG. 1B is a schematic diagram illustrating an exemplary embodiment of a full network of a machine learning model.

FIG. 10 is a schematic diagram illustrating an exemplary embodiment of an individual layer of a network.

### DETAILED DESCRIPTION OF THE INVENTION

The invention provides methods for determining a physical probability of a particle. In general, the methods described herein include obtaining, by a computing device, a spatial input of a particle. In some embodiments, and without limitation, a computing device may include one or more desktops, laptops, netbooks and tablets, handheld computers, workstations, servers, mainframes, supercomputers, quantum computers, wearables, and the like thereof. In some embodiments, and without limitation, a spatial input may include one or more locations such as but not limited to a chemical space, quantum space, and/or the like thereof. In some embodiments, and without limitation, a particle may include a proton, neutron, electron, atom, molecule, complex, and/or the like thereof. For example, and without limitation, a computing device comprising a laptop may obtain a spatial input of a particle as a function of a user input. For example, and without limitation, a user input may include a user entering one or more locations of a particle in a chemical space. In some embodiments, and without limitation, obtaining a spatial input of a particle may include receiving one or more spatial inputs from a database, wherein a “database,” as used herein is a storage of elements of data. For example, a database may store elements of data associated to locations of particles in a space, field, chemical space, and/or the like thereof. In some embodiments, and without limitation, the spatial input may include a scalar element, wherein a scalar element is described above. For example, and without limitation, a scalar element may denote one or more locations of a particle within a space, wherein the space may be defined as a number line, cartesian coordinate system, polar coordinate system, cylindrical coordinate system, spherical coordinate system, homogenous coordinate system, and/or the like thereof.

In some embodiments, the methods described herein include identifying, by the computing device, at least a tensor element as a function of the spatial input, wherein a tensor element is described above. For example, a computing device may identify a tensor element, wherein the tensor element denotes one or more symmetries, quantum fields, quantum forces, stress forces, elasticity forces, moments of inertia, electromagnetic forces, magnetic forces, general relativity forces, chemical forces, ionic forces, covalent forces, metallic forces, electrical forces, mechanical forces, optical forces, chemical properties, physical properties, dipole moments, spectroscopic transitions, and/or the like thereof. In some embodiments, and without limitation, identifying the at least a tensor element may include determining at least an external vector, wherein an external vector may include a local vector and/or a global vector as described above. For example, and without limitation, the external vector may include a plurality of local vectors representing a plurality of adjacent particles, wherein the external vector may allow for the preservation of one or more non-scalar elements of the particle, wherein non-scalar elements are described above. In some embodiments, the preservation of one or more non-scalar elements may allow for a preservation of symmetry. In some embodiments, the preservation of non-scalar properties may allow for enhanced predictions of how particles are vibrating, moving, rotating, and/or the like thereof for a plurality of applications, such as but not limited to pharmaceutical applications, semiconductor applications, and/or the like thereof. In some embodiments, and without limitation, the method described herein may identify the tensor element as a function of a plurality of external elements such that a description of an environment surrounding the particle may be generated. In some embodiments, the environment may be representative of one or more adjacent particles. For example, and without limitation, the method described herein may include identifying a many-body interaction as a function of the environment surrounding the particle. In some embodiments, the methods described may include determining a first external vector associated with a first adjacent atom, identifying a first tensor element as a function of the first external vector, determining a second external vector associated with a second adjacent atom, and identifying a second tensor element as a function of the second external vector. Additionally and/or alternatively, in some embodiments, the method described herein may include identifying the at least a tensor element and identifying a tensor product, wherein a tensor product is described below.

The methods of the invention are highly accurate and scalable, allowing for accelerating calculations relative to other computing methods. In particular, calculations may be performed simultaneously on multiple CPUs, cores, GPUs, or other compute accelerators and may be distributed among multiple computer nodes, as the method allows for calculations to be performed that are local to each particle independently of other particles. In addition, we have found that this method requires less training than other methods, while retaining high accuracy. For example, and without limitation, this method may generate highly accurate results using less training time and/or less training data.

In some embodiments, the methods described herein include determining, by the computing device, the physical probability as a function of the tensor element using a tensor machine learning model, wherein a physical probability is described above. For example, and without limitation, a physical probability may include one or more probable motions, conformation likelihoods, reactive elements, and/or the like thereof. As a further non-limiting example, physical probability may denote one or more physical, chemical, and/or optical properties of an atom, molecule, complex, material, and/or the like thereof. In some embodiments, and without limitation, a tensor machine-learning model may include one or more machine-learning processes such as supervised, unsupervised, and/or reinforcement machine-learning process. As a non-limiting example, a tensor machine-learning model may utilize one or more machine-learning process such as, but not limited to, simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In some embodiments, the tensor machine-learning model is trained as a function of a tensor training set that correlates a plurality of tensor elements to a plurality of physical probabilities. For example, and without limitation, a tensor training set may correlate a tensor element comprising symmetry with a physical probability of a predicted conformational change of a molecule. In some embodiments, the tensor training set may be received as a function of a user input comprising one or more valuations of tensor elements and/or physical probabilities. In some embodiments, tensor training set may be received as a function of receiving one or more correlations of tensor elements and/or physical probabilities that were previously received and/or determined during a previous iteration of determining physical probabilities. Additionally or alternatively, the tensor training set my be received as a function of obtaining one or more correlations of tensor elements and/or physical probabilities that were stored in a database and/or datastore. Tensor training sets may be determined using quantum calculations. In some embodiments, and without limitation, the database and/or datastore may be located in the computing device and/or out of the computing device, wherein the computing device receives the correlations from the database and/or datastore as a function of one or more incoming signals, transmissions, inputs, and/or the like thereof.

In some embodiments, the method described herein may determine a first physical probability, wherein the computing device may receive an alternate spatial input of the particle. As used herein, an “alternate spatial input” is a spatial input associated with an adjacent particle and/or distal particle. For example, and without limitation an alternate spatial input may include spatial input associated with a primary atom, secondary atom, tertiary atom, quaternary atom, and/or the like thereof. The method described herein may generate a second physical probability as a function of the alternate spatial input. As used herein, a “second physical probability” is an updated and/or revised physical probability of the particle, wherein the updated and/or revised physical probability may differ from the first physical probability. In some embodiments, the method described herein may update the tensor training set as a function of the first physical probability and determine the second physical probability as a function of the updated tensor training set. For example, and without limitation, updating the tensor training set may include replacing and/or altering, one or more weights and/or valuations of the correlations associating tensor elements and physical probabilities.

In some embodiments, the disclosure provides a computing system programmed to carry out the method as described herein. In some embodiments, the disclosure provides a non-volatile computer readable memory storing instructions to carry out the method of the invention.

Energy Decomposition

In some embodiments, an assumption of the decomposition of the potential energy of a system into per-particle energies Eᵢ may be calculated:

$${E}_{system} = {\sum }_{i}^{N} {σ}_{{Z}_{i}} {E}_{i} + {μ}_{{Z}_{i}}$$

where σ_{z}and μ_{z}_{ᵢ} are (optionally trainable) per-species scales and shifts.

In some embodiments, a further decomposition may be performed to decompose the per-particle energy into a sum over pairwise energies indexed by the central particle and one of its neighbors

$${E}_{i} = {\sum }_{j}^{N} {σ}_{{Z}_{i} , {Z}_{j}} {E}_{ij} + {μ}_{{Z}_{i} , {Z}_{j}}$$

where j ranges over the neighbors of particle i. The per-pair-species scalings and shifts σ_{z}_{_{i,}}_{z}_{ⱼ} and β_{z}_{_{i,}}_{z}_{ⱼ} may be optional. In some embodiments, these pairwise energies may be indexed by a particle and/or an alternate particle, they are not two- body; rather, they depend on the entire neighborhood of particle i and thus can represent a many body potential.

### Forces

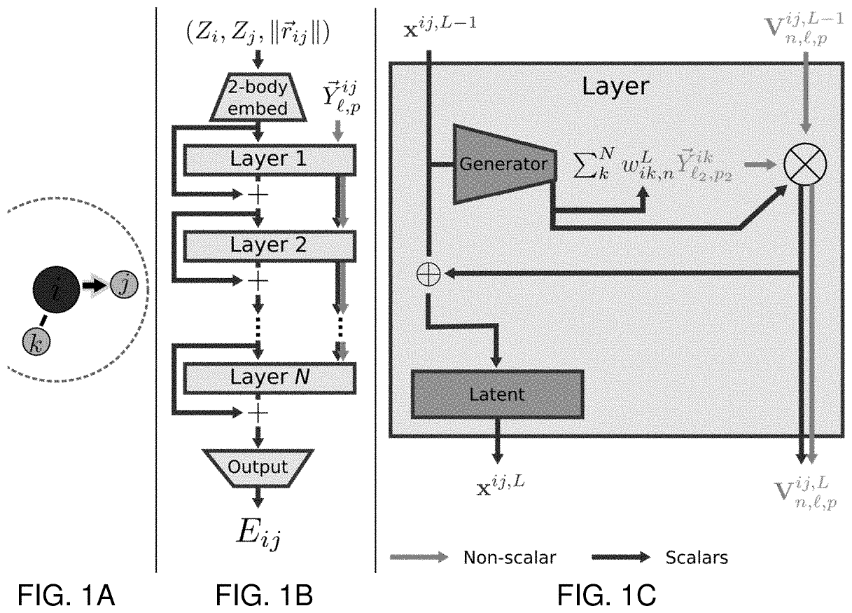

Referring now to FIG. 1A, a system of particles may include a plurality of forces. In some embodiments, the forces on particle a, \vec{Fₐ}, may be computed using autodifferentiation according to their physical definition as the negative gradient of the total energy with regard to the position of particle a

\vec{Fₐ}=−∇_{aΣsystem}

By linearity, this may be a weighted sum of gradients of the pairwise energies −∇_{aΣij}, wherein the constant terms may drop out. Because each Σᵢⱼ depends only on the particles in the neighborhood of particle i, −∇_{aΣij}≠0 only when i=a and/or when i≠a has particle a as a neighbor. Thus, non-zero force terms are either of the form —VₐEₐⱼ, which may depend only on the neighborhood of particle a, or particle i, a neighbor of particle a. As used herein, the term “*” represents any of the neighbors of particle i, including a. These groups of terms may be computed independently for each central particle, which facilitates parallelization: the contributions to the force on particle a due to the neighborhoods of various different particles can each be computed in parallel by whichever worker is currently assigned the relevant center's neighborhood. The final forces are then a simple sum reduction over force terms form various workers.

### Multi-Layer Equivariant Tensor Products

In some embodiments, and now referring to FIG. 1 B, a machine-learning model may be an arbitrarily deep equivariant neural network with N_{layers} layers.

In some embodiments a deep equivariant network may include learnable weights, wherein the learnable weights may be scalars and non-scalars may be treated by equivariant operations. In some embodiments, splitting each layer into learnable invariant scalar networks and/or separate equivariant tensor product operations may be performed. This split may allow for the multiplicity of the equivariant latent space n_{equivariant}, and thus the dominant computational cost of the model, to be controlled independently from the dimension n_{scalar} of the learnable part.

Initial two-body latent embedding

Before the first layer, the initial scalar features x^{ij,L=0} may be produced by a nonlinear embedding network:

x^{ij,L=0}=MLP_{two-body}(1HOT(Zⱼ); B(∥\vec{rₗⱼ}∥))

where ; denotes concatenation, 1HOT (·) is a one-hot encoding of the discrete species of the center and neighbor particles i and j, and

B(∥\vec{rₗⱼ}∥)=(B₁((∥\vec{rₗⱼ}∥); . . . ; B_{N} _{_{basis}} (ν\vec{rₗⱼ}))

is the projection onto a radial basis.

The initial equivariant features V_{n,l,p}^{ij,L=0} may be set as the spherical harmonic projection of the edge ij:

V_{n,l,p}^{ij,L=0}=\vec{Y_{l,p}^{lj}}

where the n index takes only one value n=0. Alternatively, the initial equivariant features may be set using a simple learned linear embedding

V_{n,l,p}^{ij,L=0}=w_{ij,n}^{L=0}\vec{Y_{l,p}^{lj}}

where n runs over an arbitrary number of embedded multiplicities and the scalar weights for each neighbor ij are computed from the two-body scalar embedding:

w_{ij,n}^{L=0}=MLP_{generator}^{L=0}(x^{ij,L=0})

In either case, the initial features may contain only irreducible representations that are contained in the spherical harmonics.

### Layer Architecture

In some embodiments, and now referring to FIG. 10, each layer may include three components: a scalar weight generator MLP, an equivariant tensor product using those weights, and a scalar MLP to update the scalar latent space with scalar information from the tensor product.

### Tensor Product

In some embodiments, and without limitation, new equivariant features may be generated to incorporate higher-order correlations of other neighbor particles into the state of each center-neighbor pair ij such that the new state is computed as a weighted sum of the tensor products of the current features with the geometry of the various neighbors in the local environment:

$${V}_{n , {l}_{out} , {p}_{out}}^{ij , L = 0} = {\sum }_{k}^{N} {\sum }_{{l}_{1} , {p}_{1} , {l}_{2} , {p}_{2}} {w}_{ik , n , {l}_{out} , {p}_{out} , {l}_{1} , {p}_{1} , {l}_{2} , {p}_{2}}^{L} \cdot {w}_{ik , n}^{L} ( {V}_{n , {l}_{1} , {p}_{1}}^{ij , L - 1} ⊗ \vec{{Y}_{{l}_{2} , {p}_{2}}^{ι k}} ) = {\sum }_{{l}_{1} , {p}_{1} , {l}_{2} , {p}_{2}} {w}_{ik , n , {l}_{out} , {p}_{out} , {l}_{1} , {p}_{1} , {l}_{2} , {p}_{2}}^{L} [ {V}_{n , {l}_{1} , {p}_{1}}^{ij , L - 1} ⊗ ( {\sum }_{k}^{N} {w}_{ik , n}^{L} \vec{{Y}_{{l}_{2} , {p}_{2}}^{ι k}} ) ]$$

where k ∈ N ranges over the neighborhood of the central particle i. The second line follows by the bilinearity of the tensor product; this reorganization importantly may express the update in terms of one tensor product, rather than one for each neighbor k.

In some embodiments, the (l, p) indices on the previous layer's features (l₁,p₁) and on the edge spherical harmonic projection (l₂,p₂) may not be the same; the tensor product may be capable of mixing each pair (l₁, p₁), (l₂, p₂) to produce a range of allowable (lₒᵤₜ, pₒᵤₜ)s. The various different paths leading to the same (lₒᵤₜ, pₒᵤₜ) pair may be combined in a sum weighted by w_{iK,n,l}_{_{out,}}_{P}_{ₒᵤₜ}ₗ_{_{1,}}ₚ_{_{1,}}ₗ_{_{2,}} ₚ_{₂}, which may exist for symmetrically valid combinations of the input and output irrep indexes. In some embodiments, these path-mixing weights may be learned for each center-neighbor pair as a function of the previous scalar featurization of the pair:

w_{iK,n,l}_{_{out,}}ₚ_{_{out,}}ₗ_{_{1,}}ₗ_{_{2,}}ₚ_{₂}^{L}=MLP_{generator}(x^{ik,L-1})

The number of such weights for each center-neighbor pair may be fixed by the lₘₐₓ, and n hyperparameters, which may allow for the use of a fixed dimension MLP. Alternatively, if the ij dependence is ignored, these path mixing weights can be learned directly as a per-layer weight vector shared over all center-neighbor pairs.

While the tensor product may be capable of generating higher l values than appear in any of its inputs, for performance reasons, a truncation such that the allowed lₒᵤₜs do not exceed lₘₐₓmay be performed.

### Environment Embedding

In some embodiments, the tensor product argument, τₖ^{N}w_{ik,n}^{L}{right arrow over (Yₗ_{_{2,}}ₚ_{₂}^{lk})}. This can be viewed as the spherical harmonic basis projection of a weighted local atomic density. In some embodiments, this method includes an “embedded environment” of particle i, wherein an embedded environment of particle i may be referred to as τₖ^{N}w_{ik,n}{right arrow over (Yₗ_{_{2,}}ₚ^{lk})}. In some embodiments, the learned scalar featurization of each center-neighbor pair from previous layers may be utilized to learn the embedding weights

W_{ik,n}^{L}=MLP_{generator(x}^{ik,L-1})^{L}.

In some embodiments, the generator may be a simple one-layer linear projection of the latent space.

### Latent MLP

In some embodiments, each layer may reincorporate the scalar information resulting from the tensor product into the scalar latent space:

x^{ij,L}=MLPₗₐₜₑₙₜ^{L}(x^{ik,L-1}; Vₗ_{ₒᵤₜ}^{ij,L}=0, pₒᵤₜ=1)

The output dimension of MLP_{latent latent} may be n_{scalar}. This operation couples the scalar and equivariant “tracks” of the model: because sometimes (l₁, p₁), (l₂, p₂) ≠ (lₒᵤₜ,pₒᵤₜ), the scalars Vᵢ_{ₒᵤₜ}_{=0, p}_{ₒᵤₜ}₌₁^{ij,L} may integrate information previously only available to the non-scalar (equivariant) latent space into the scalar latent space.

### Residual Update

In some embodiments a residual update with a learned ratio a_{L} between the new and old scalar latent space features may be utilized:

$${x}^{ij , L} = \frac{1}{1 + {α}_{L}} {x}^{ij , L - 1} + \frac{{α}_{L}}{1 + {α}_{L}} {x}^{ij , L}$$

The learned ratio a_{L} is a trainable scalar, one for each layer. The residual update may be performed in the scalar latent space because the irreducible representations (l and parity tuples) that are symmetrically allowed in the equivariant latent space may change from layer to layer, making a residual update in that space ill-defined.

In some embodiments, the forms of the coefficients may enforce normalization. For example, and without limitation, if at initialization x^{ij,L-1} and X^{ij,L} are negligibly correlated and each have approximately unit variance, the residual sum will then also have approximately variance 1.

In some embodiments, the importance ratio to the next layer may be parameterized by:

α_{L}=σ(α_{L}′)

wherein α_{L}′ is the learnable weight and Υ is the sigmoid function. This means that 0<α_{L}<1, ensuring that (1) all layers contribute to the final output because a_{L}, ≠0 and (2) no layer can contribute more on average than the previous layer at initialization. In some embodiments, the restriction may encourage the network to learn as much of the target as possible at as early a layer as possible. In some embodiments, this restriction may reduce overfitting.

### Output Block

In some embodiments, a prediction of Eᵢⱼ may be performed, wherein the prediction may include applying a fully connected neural network with output dimension 1 to the latent features output by the final layer:

Eᵢⱼ=MLPₒᵤₜₚᵤₜ(x^{ij,L=N}^{_{layer}})

### Model Variations

Energies decomposed by unique body-order

In some embodiments, the total potential energy of a system of N identical particles can be written as an expansion of clusters of correlated particles:

$$E ( \vec{{r}_{1}} , \vec{{r}_{2}} , … , \vec{{r}_{N}} ) = {E}_{0} + {\sum }_{i}^{N} {E}_{{Z}_{i}} + {\sum }_{ij}^{N} {E}_{2} ( \vec{{r}_{ι}} , \vec{{r}_{}} ) + {\sum }_{ijk}^{N} {E}_{3} ( \vec{{r}_{ι}} , \vec{{r}_{}} , \vec{{r}_{k}} ) + …$$

where the potentials Eₖ are symmetric (permutation invariant) in their arguments, E₀ is an arbitrary reference energy, and E_{z}_{ᵢ} is the chemical potential of particle i which cannot depend on position. Such an expansion may be called a cluster potential.

In some embodiments, a contribution of energies of pairs of particles Eᵢⱼ may be utilized:

$$E ( \vec{{r}_{1}} , \vec{{r}_{2}} , … , \vec{{r}_{N}} ) = {E}_{0} + {\sum }_{i = 1}^{N} {E}_{{Z}_{i}} + {\sum }_{ij}^{N} {E}_{ij}$$

In some embodiments, the pair energy may be performed as a series expansion involving the 2-plet energy of the pair (i,j) and all higher order clusters that include this pair of particles, e.g. all triples (i,j,k) including (i,j), all quadruples, and so on:

$${E}_{ij} = {E}_{ij}^{K = 2} ( \vec{{r}_{ι}} , \vec{{r}_{}} ) + {\sum }_{k}^{N} {E}_{ij}^{K = 3} \vec{( {r}_{ι}} , \vec{{r}_{}} , \vec{{r}_{k}} ) + {\sum }_{k , l}^{N} {E}_{ij}^{K = 4} \vec{( {r}_{ι}} , \vec{{r}_{}} , \vec{{r}_{k}} , \vec{{r}_{l}} ) + …$$

In some embodiments, the expansion may suggest a further energy decomposition for the tensor machine learning model, which can be implemented as follows. In the tensor machine-learning model, each layer may output in the equivariant latent space the tensor product between the previous equivariant latents and an embedded environment. The embedded environment may be geometrically two-body: while it could include higher correlation-order information from the embedding weights, the embedded environment may still be a sum over two body geometric tensors (the spherical harmonic projections of the displacement vectors \vec{rᵢⱼ}). The initial equivariant latent space at layer L=0 may also be two body, containing the spherical harmonic projection of the current center-neighbor pair. In some embodiments, the first layer may involve a tensor product between equivariants indexed by ij(the equivariant feature space) and those indexed by ik (the embedded environment), wherein the first layer may yield an output that includes 3-body unique (geometric) correlation terms where j≠k. Similarly, the next layer may involve a tensor product between these features, which may now contain terms indexed by ijk, and another embedded environment, introducing correlations with a fourth particle and yielding 4-body unique correlation terms.

In some embodiments, this correlation order may also apply to the scalar outputs of the tensor product. For example, the correlation may denote a ceiling on the unique body order of the information contained in the scalar latent space after each layer. The ceiling may increase with each layer, wherein the ceiling may define that:

Eᵢⱼ^{K}=MLP_{extractor}(x^{ij,L=K-2})

where the extractor is a linear MLP projecting the scalar latent space from layer K−2 into a single scalar Eᵢⱼ^{K}. Clearly, Kₘₐₓ=N_{layer}+2. In some embodiments, the final pairwise energy may be determined by the expansion described above.

Energies Strictly Decomposed by Body-Order

In some embodiments, because each layer's latent MLP may freely mix new scalars from the tensor product with scalar latents from the previous layer, the unique body order of x^{ij,L=K-2}—and thus Eᵢⱼ^{K}—may have only an upper and not lower bound of K. (Its lower bound may be K=2, since information from the initial two-body features can propagate to any layer.) Scalar information from previous layers may also be propagated by the residual update.

Additionally or alternatively, because the scalars used in the weighting of the embedded environment at layer L (where K=L+2) are themselves based on K=L+1 information from the last layer, they may also introduce further non-unique increases in the body order.

In some embodiments, a construction of a variation of the model whose energies are strictly ordered with regard to body order may be constructed by (1) removing the residual update and scalar latent space and (2) extracting Eᵢⱼ^{K} directly from the scalars in the tensor product output:

Eᵢⱼ^{K=MLP}_{extractor}(Vₗ_{ₒᵤₜ}_{=0,p}_{ₒᵤₜ}₌₁^{ij,L=1})

Note that if the extractor MLPs is linear then the body-ordering may hold. The layer update step may then retain only the equivariant feature update on particle i. Also, the environment embedding weights may be generated only from the two-body scalars (the initial L=0 scalars) in order to eliminate any additional non-unique many-body correlations:

w_{ik,n}^{L=MLP}_{generator}^{(x}^{ik,L=0})

In some embodiments, this variation may include no x^{ik,L} for L>0.

### Other Embodiments

While the invention has been described in connection with specific embodiments thereof, it will be understood that it is capable of further modifications and this application is intended to cover any variations, uses, or adaptations of the invention following, in general, the principles of the invention and including such departures from the invention that come within known or customary practice within the art to which the invention pertains and may be applied to the essential features hereinbefore set forth, and follows in the scope of the claims. Other embodiments are within the claims.

What is claimed is:

1. A method for determining a physical probability of a particle, wherein the method for determining a physical probability of a particle comprises:
obtaining, by a computing device, a spatial input of a particle;
identifying, by the computing device, at least a tensor element as a function of the spatial input; and
determining, by the computing device, the physical probability as a function of the tensor element using a tensor machine learning model, wherein the tensor machine learning model is trained as a function of a tensor training set that correlates a plurality of tensor elements to a plurality of physical probabilities.

2. The method of claim 1, wherein the spatial input comprises a scalar element.

3. The method of claim 1, wherein identifying the at least a tensor element further comprises:
determining at least an external vector; and
identifying the tensor element as a function of the at least an external vector.

4. The method of claim 3, wherein the external vector includes a local vector.

5. The method of claim 3, wherein the external vector includes a global vector.

6. The method of claim 1, wherein the physical probability comprises a probable motion.

7. The method of claim 1, wherein the physical probability comprises a conformation likelihood.

8. The method of claim 1, wherein the physical probability comprises a reactive element.

9. The method wherein 1, wherein determining the physical probability further comprises:
determining a first physical probability;
receiving an alternate spatial input of the particle; and
generating a second physical probability as a function of the alternate spatial input.

10. The method of claim 9, wherein determining the physical probability further comprises:
updating the tensor training set as a function of the first physical probability; and
determining a second physical probability as a function of the updated tensor training set.

11. A method for simulating molecular dynamics, wherein the method comprises accelerating, by a computing device, a computation associated with a force of a particle.

12. A method for performing an interpolation analysis of a plurality of forces associated with a particle,
wherein the method comprises:
receiving, by a computing device, a plurality of forces associated with a particle from at least a quantum mechanical calculation; and
performing, by the computing device, an interpolation analysis of the plurality of forces associated with the particle as a function of a machine learning model.

13. A method for performing a regression of a plurality of forces associated with a particle, wherein the method comprises:
receiving, by a computing device, a plurality of forces associated with a particle from at least a quantum mechanical calculation; and
performing, by the computing device, a regression analysis as a function of the plurality of forces associated with the particle and a machine learning model.

14. A method for learning a plurality of forces associated with a particle, wherein the method comprises:
generating, by a computing device, a gradient of a total energy predicted by a neural network architecture, wherein generating further comprises:
capturing a geometric information about a spatial element and categorical element of an alternate particle in a local neighborhood surrounding a particle; and
generating the gradient as a function of the geometric information using a neural network architecture; and
learning, by the computing device, a plurality of forces associated with the particle as a function of the gradient.

15. A method for learning a plurality of forces associated with a particle, wherein the method comprises:
generating, by a computing device, a gradient of a total energy, wherein generating further comprises:
predicting, as a function of a neural network architecture that captures many-body geometric information about a spatial element and a categorical element of an alternate particle within a neighborhood of the particle in a pair relative to the alternate particle, a pairwise energy; and
decomposing the gradient into a sum of pairwise energy terms corresponding to all ordered pairs of alternate particles; and
learning, by the computing device, a plurality of forces associated with a particle as a function of the gradient.

16. The method of claim 15, wherein the neural network architecture is configured to be equivariant to E(3) symmetry operations.

17. The method of claim 15, wherein the neural network architecture is configured to exchange a plurality of invariant scalar information as a function of being split into two tracks, wherein the two tracks include an E(3)-invariant track and an E(3)-equivariant track.
